(19) United States
(12) Patent Application Publication
(10) Pub. No.: US 2026/0346675 A1
(43) Pub. Date: Nov. 5, 2026

(54) REFRIGERANT MODULE OF VEHICLE HEAT PUMP SYSTEM AND MAINTENANCE METHOD THEREOF

(71) Applicants: HYUNDAI MOTOR COMPANY, Seoul (KR); Kia Corporation, Seoul (KR)

(72) Inventors: Chang Min PARK, Hwaseong-si (KR); Seong-Bin JEONG, Hwaseong-si (KR)

(21) Appl. No.: 19/536,819

(22) Filed: Feb. 11, 2026

(30) Foreign Application Priority Data
Apr. 30, 2025 (KR) 10-2025-0057343

(51) Int. Cl. B60H 1/00

(52) U.S. Cl. CPC B60H 1/00278

(57) ABSTRACT

A refrigerant module for a vehicle heat pump system and a maintenance method therefor are disclosed. The method, performed by an apparatus of a vehicle, may include performing an initial calibration on a plurality of refrigerant valves to determine a plurality of pieces of valve calibration information; storing each of the plurality of pieces of valve calibration information in a memory of a hall sensor installed for a corresponding refrigerant valve of the plurality of refrigerant valves; based on a first refrigerant valve of the plurality of refrigerant valves being replaced due to a failure, obtaining a first piece of the valve calibration information stored in the memory of the hall sensor installed in the first refrigerant valve; and calibrating, based on the first piece of the valve calibration information, tolerance of a second refrigerant valve that replaced the first refrigerant valve.

### CROSS-REFERENCE TO RELATED APPLICATION

This application claims priority to and the benefit of Korean Patent Application No. 10-2025-0057343, filed in the Korean Intellectual Property Office on Apr. 30, 2025, the entire contents of which are incorporated herein by reference.

### TECHNICAL FIELD

The present disclosure relates to a refrigerant module of a heat pump system for a vehicle and a maintenance method therefor, and more particularly, to a refrigerant module applied to a modular heat pump system for an electric vehicle and a maintenance method therefor.

### BACKGROUND

A vehicle heat pump system (hereinafter referred to as a “heat pump”) is a heating and cooling device that transfers heat from a low-temperature heat source to a high-temperature heat source or transfers heat from a high-temperature heat source to a low-temperature heat source by using heat generation or condensation heat of a refrigerant.

A heat pump system typically applied to an electric vehicle (EV) may serve as an integrated thermal management system that performs interconnection of a drive motor, a power electronic device, and a battery while maintaining an appropriate temperature within the vehicle interior.

In order for a heat pump to perform integrated thermal management for indoor air conditioning and electrical components, many parts and valves related to refrigerant lines and coolant lines must be precisely assembled and maintained (e.g., serviced, replaced, etc.) throughout their lives.

The above information disclosed in this Background section is only for enhancement of understanding of the background of the present disclosure, and therefore, it may contain information that does not form the prior art that is already known in this country to a person of ordinary skill in the art.

### SUMMARY

The purpose of the present disclosure is to provide a refrigerant module of a vehicle heat pump system capable of improving system performance and reliability and a maintenance method thereof by performing tolerance correction using valve correction information stored in a memory of a corresponding hall sensor when replacing a single refrigerant valve in a refrigerant module that comprehensively controls a plurality of refrigerant valves.

According to one or more example embodiments of the present disclosure, a method performed by an apparatus of a vehicle may include: performing, by control circuit of a vehicle heat pump, an initial calibration on a plurality of refrigerant valves, mounted in a refrigerant distribution panel associated with the vehicle heat pump, to determine a plurality of pieces of valve calibration information. Each of the plurality of pieces of valve calibration information may be associated with one of the plurality of refrigerant valves. The method may further include: storing, by the control circuit, each of the plurality of pieces of valve calibration information in a memory of a hall sensor installed for a corresponding refrigerant valve of the plurality of refrigerant valves; based on a first refrigerant valve of the plurality of refrigerant valves being replaced due to a failure, obtaining, by the control circuit, a first piece of the valve calibration information stored in the memory of the hall sensor installed in the first refrigerant valve; and calibrating, based on the first piece of the valve calibration information, tolerance of a second refrigerant valve that replaced the first refrigerant valve.

Performing the initial calibration may include, for each refrigerant valve of the plurality of refrigerant valves: obtaining, via a transceiver of the vehicle heat pump, a hall sensor identifier of the hall sensor corresponding to the refrigerant valve; moving the refrigerant valve in a first direction by a first predetermined movement amount and storing a first output value of the hall sensor corresponding to the refrigerant valve; moving the refrigerant valve in a second direction, opposite of the first direction, by a second predetermined movement amount and storing a second output value of the hall sensor corresponding to the refrigerant valve; and verifying whether a difference between the first output value and the second output value satisfies a reference error range.

Verifying may include: based on the difference between the first output value and the second output value not satisfying the reference error range, incrementing an error correction count for the refrigerant valve; and performing the initial calibration repeatedly.

Verifying may include: determining, based on the difference between the first output value and the second output value satisfying the reference error range, that the refrigerant valve is operating within a normal operational range. Each of the plurality of pieces of valve calibration information may include at least one of: the hall sensor identifier, a refrigerant valve identifier of the refrigerant valve, an error correction count, or a valve correction value for each count.

Verifying may further include: based on the error correction count being greater than a threshold count, storing, in the memory of the hall sensor corresponding to the refrigerant valve, a correction value for each of the error correction count cumulatively.

Obtaining the first piece of the valve calibration information may include: detecting the failure in the first refrigerant valve; and obtaining, based on the first refrigerant valve being reinstalled in the vehicle heat pump as the second refrigerant valve, a hall sensor identifier, of the hall sensor installed in the first refrigerant valve, and the first piece of the valve calibration information stored in the memory of the hall sensor installed in the first refrigerant valve.

Obtaining the first piece of the valve calibration information may include: obtaining at least one of: a hall sensor identifier, a current refrigerant valve identifier, an error correction count, or a valve correction value for each count.

Obtaining the first piece of the valve calibration information may further include: determining whether the first refrigerant valve is different from the second refrigerant valve by comparing the current refrigerant valve identifier in the valve calibration information with an immediately preceding stored refrigerant valve identifier; and determining, based on the current refrigerant valve identifier and the immediately preceding stored refrigerant valve identifier being different, that the second refrigerant valve is different from the first refrigerant valve.

Calibrating the tolerance of the second refrigerant valve may include: performing hysteresis correction on the second refrigerant valve based on the valve correction value stored in the first piece of the valve calibration information; and calibrating, based on the error correction count in the first piece of the valve calibration information being greater than a threshold count, the tolerance using a correction value sum for the error correction count.

Obtaining the first piece of the valve calibration information may include: determining, based on the current refrigerant valve identifier being identical to an immediately preceding stored refrigerant valve identifier, that the first refrigerant valve has been reinstalled as the second refrigerant valve; and terminating a replacement process without calibration based on confirming that the second refrigerant valve is operating within a predetermined normal operational range.

According to one or more example embodiments of the present disclosure, an apparatus may include: a plurality of refrigerant valves each installed on a functional cooling line formed in a refrigerant distribution panel; and a plurality of hall sensors; and a control circuit. Each hall sensor of the plurality of hall sensors may be installed for a corresponding refrigerant valve of the plurality of refrigerant valves. Each hall sensor of the plurality of hall sensors may include a memory. The control circuit may include a micro controller unit (MCU) and a transceiver and configured to control the plurality of refrigerant valves via the plurality of hall sensors. The control circuit may be further configured to perform an initial calibration on the plurality of refrigerant valves to determine a plurality of pieces of valve calibration information. Each of the plurality of pieces of valve calibration information may be associated with one of the plurality of refrigerant valves; store each of the plurality of pieces of valve calibration information in the memory of a corresponding hall sensor of the plurality of hall sensors. The control circuit may be further configured to, based on a first refrigerant valve of the plurality of refrigerant valves being replaced due to a failure, calibrate, based on a first piece of the valve calibration information stored in the memory of the hall sensor corresponding to the first refrigerant valve, tolerance of a second refrigerant valve that replaced the first refrigerant valve.

The apparatus may further include: a composite heat exchanger configured to cool or heat a vehicle interior using a refrigerant; and a battery chiller configured to cool, using a coolant that undergoes heat exchange via the refrigerant, a battery.

Each of the plurality of pieces of valve calibration information may include a refrigerant valve identifier and a hysteresis correction value that are matched with a hall sensor identifier during the initial calibration.

The control circuit may be further configured to: determine whether the second refrigerant valve is different from the first refrigerant valve by comparing a current refrigerant valve identifier in the first piece of the valve calibration information with an immediately preceding stored refrigerant valve identifier; and, based on the current refrigerant valve identifier and the immediately preceding stored refrigerant valve identifier being different, determine that the second refrigerant valve is different from the first refrigerant valve and calibrate the tolerance of the second refrigerant valve.

The control circuit may be further configured to: based on a current refrigerant valve identifier in the first piece of the valve calibration information and an immediately preceding stored refrigerant valve identifier being identical, determine that the first refrigerant valve has been reinstalled as the second refrigerant valve, and terminate a replacement process without calibrating the second refrigerant valve.

According to one or more example embodiments of the present disclosure, an apparatus may include: a valve receptacle configured to receive one or more valves that are configured to control a flow rate of a refrigerant flowing through a refrigerant line; and a control circuit configured to: based on a first valve, including a first memory, being installed in the valve receptacle, transmit, to the first valve, a first signal configured to cause the first valve to rotate in a first direction by a predetermined amount; transmit, to the first valve, a second signal configured to cause the first valve to rotate in a second direction by the predetermined amount; determine, based on a difference between a first measured rotation amount of the first valve according to the first signal and a second measured rotation amount of the first valve according to the second signal, a first calibration value for the first valve; and store, in the first memory of the first valve, the first calibration value.

The control circuit may be further configured to detect that the first valve is removed from the valve receptacle and a second valve is installed in the valve receptacle. The second valve may include a second memory. The control circuit may be further configured to, based on detecting that the second valve is installed in the valve receptacle, retrieve a second calibration value stored in the second memory of the second valve.

The control circuit may be further configured to: obtain, based on the first valve being installed in the valve receptacle, a first valve identifier of the first valve; and obtain, based on the first valve being removed from the valve receptacle and the second valve being installed in the valve receptacle, a second valve identifier of the second valve.

The control circuit may be further configured to: based on the second valve identifier being different from the first valve identifier stored in the second memory, applying the retrieved second calibration value to the second valve.

The control circuit may be further configured to: based on the second valve identifier being identical to the first valve identifier stored in the second memory, determining an operational condition of the second valve without applying the retrieved second calibration value to the second valve.

### BRIEF DESCRIPTION OF THE DRAWINGS

FIG. 1 and FIG. 2 illustrate a configuration of an example pump system for a vehicle and a refrigerant module applied thereto.

FIG. 3 illustrates a schematic block diagram for describing a control configuration of an example integrated refrigerant module.

FIG. 4 and FIG. 5 illustrate example operation methods of a refrigerant module of a heat pump system.

FIG. 6 illustrates a valve control structure provided in the refrigerant line of a heat pump.

FIG. 7 illustrates a valve control structure equipped in a conventional improved modular heat pump refrigerant module.

FIG. 8 shows an example computing system.

### DETAILED DESCRIPTION

The present disclosure will be described more fully hereinafter with reference to the accompanying drawings, in which one or more example embodiments of the disclosure are shown. However, as those skilled in the art would realize, the described example embodiment(s) of the present disclosure may be modified in various different ways, all without departing from the spirit or scope of the present disclosure. To clearly describe the disclosure in the drawings, unrelated descriptions have been omitted. Throughout the entire specification, similar parts are assigned similar reference numerals.

Throughout the entire specification, the terminologies used herein are for the purpose of describing particular only and is not intended to limit the present disclosure. As used herein, singular forms are intended to include plural forms as well, unless explicitly stated otherwise in the context. The terms “comprise” and/or “comprising,” when used herein, specify the recited features, integers, steps, acts, elements and/or presence of components, but it will also be understood that this does not exclude the presence or addition of one or more of other features, integers, steps, acts, elements, components, and/or groups thereof. As used herein, the term “and/or” includes any one or all combinations of the associated listed items.

Throughout the specification, the terms first, second, A, B, (a), (b), etc. may be used to describe elements of various configurations, but the components should not be qualified by the terms. These terms are only for distinguishing the constituent elements from other constituent elements, and the nature, sequences, or orders of the constituent elements are not limited by the terms.

Throughout the specification, it is to be understood that when one component is referred to as being “connected” or “coupled” to another component, it may be connected or coupled directly to the other component or may be connected or coupled to the other component with a further component intervening therebetween. However, it is to be understood that when one component is referred to as being “connected” or “coupled directly” to another component, it may be connected to or coupled to the other component without being connected to a component intervening therebetween.

Additionally, it is understood that one or more of the following methods or aspects thereof may be executed by at least one controller. The term “controller’ may refer to a hardware device that includes a memory and a processor.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

The memory is configured to store program instructions, and the processor is specifically programmed to execute the program instructions to perform one or more processes described in further detail below. The controller, as described herein, may control operations of units, modules, components, devices, or similar elements. Furthermore, it is understood that the following methods are able to be executed by a device that includes a controller along with one or more other components, as recognized by those skilled in the art.

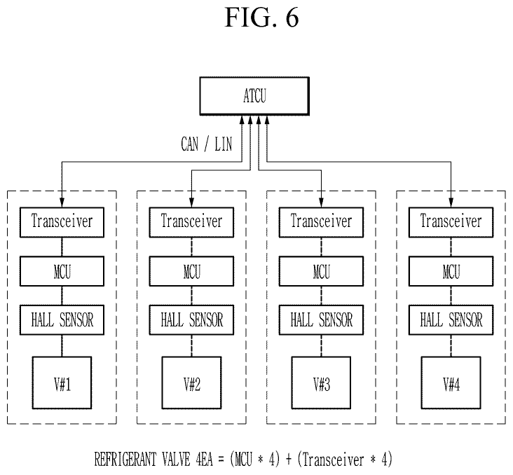

FIG. 6 shows a valve control structure provided in the refrigerant line of a heat pump.

Referring to FIG. 6, an implementation of a heat pump refrigerant line may be equipped with four valves (e.g., ball valves V) according to different flow functions. In this example, four valves V #1, V #2, V #3, and V #4 may be respectively equipped with a hall sensor (e.g., Hall integrated circuit (IC)), a micro controller unit (MCU), and a transceiver for precise calibration and driving. Additionally, each of the valves V #1, V #2, V #3, and V #4 may be controlled by an upper air conditioning controller (e.g., auto temperature control unit (ATCU)) connected through vehicle communication (e.g., controller area network (CAN) and/or local interconnect network (LIN)).

When setting up each of the valves V #1, V #2, V #3, and V #4, individual step tolerance correction values may be stored in a memory of the corresponding MCU. In addition, if a single valve is replaced due to a malfunction, the MCU may perform initial calibration by applying the tolerance correction value stored in the memory, thereby ensuring precise measurement performance. However, each valve (V #1, V #2, V #3, and V #4) may be equipped with a hall sensor (Hall IC), a micro controller unit (MCU), and a transceiver of its own, which has disadvantages of increased manufacturing process and cost.

Accordingly, an improved modular heat pump system may integrate functions through modularized refrigerant modules and coolant modules, simplifying a number of parts and a manufacturing process.

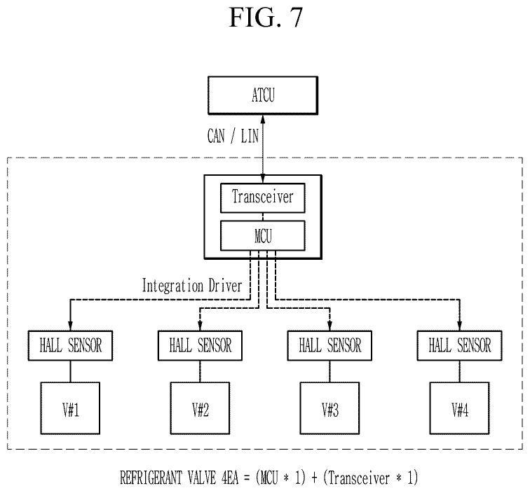

FIG. 7 shows a valve control structure equipped in an improved modular heat pump refrigerant module.

Referring to FIG. 7, a refrigerant module of the improved modular heat pump may be equipped with a hall sensor (Hall IC) for each of four V #1, V #2, V #3, and V #4, and each valve (V #1, V #2, V #3, and V #4) may be driven through an integrated driver using a single (e.g., centralized) MCU and a single (e.g., centralized) transceiver.

However, after entering an individual step tolerance correction value for each valve (V #1, V #2, V #3, and V #4) into a memory of a unified MCU, if a single refrigerant valve fails and is replaced, the corresponding tolerance correction value may not be applicable (e.g., it becomes useless). That is, if a refrigerant valve is replaced and there is no information on the previous component's calibration, it may be difficult to calibrate the new refrigerant valve. If the refrigerant valve is not calibrated, a problem may arise where the refrigerant flow rate for the new refrigerant valve may be different from what it was for the previous refrigerant valve, causing a deterioration in system performance.

Accordingly, an improved correction method may be needed to address an issue that arises when replacing an individual refrigerant module valve.

A cartridge type refrigerant valve module of a heat pump system for a vehicle and a valve replacement method thereof according to the present disclosure will be described in detail with reference to the drawings.

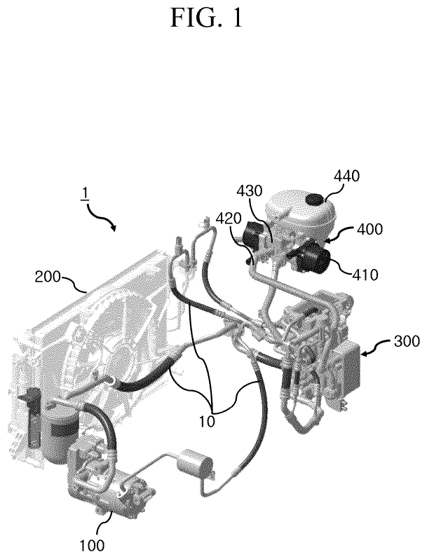

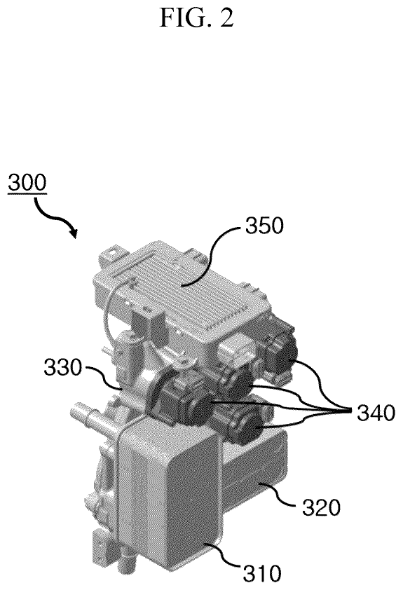

FIG. 1 and FIG. 2 illustrate a configuration of an example pump system for a vehicle and a refrigerant module applied thereto.

Referring to FIGS. 1 and 2, a vehicle may be an electric vehicle (or hydrogen electric vehicle) driven by electricity charged in a high-voltage battery 30 as a power source, or a purpose-built vehicle (PBV) based on an electric vehicle.

A heat pump system 1 for a vehicle may include a coolant module 400 and a refrigerant module 300 circulating a refrigerant that has undergone a phase change through a compressor 100 and a condenser 200 through a refrigerant line 10, and air conditioning of a vehicle interior 20 and heat management of the battery 30 may be performed through the circulated refrigerant and a coolant. In this case, the refrigerant may be introduced into the compressor 100 in a gaseous state, compressed at high temperature and high pressure, and converted into a liquid refrigerant by releasing heat while passing through the condenser 200, and then converted into low temperature and low pressure vapor through a plurality of refrigerant valves 340 in the refrigerant module 300, and then may be circulated through a path where it becomes a gaseous state again through an evaporator (not shown).

The refrigerant module 300 may include a composite heat exchanger 310 that uses a refrigerant to cool/heat the vehicle interior 20, a battery chiller 320 that uses a coolant heat-exchanged through the refrigerant to cool the battery 30, the refrigerant valves 340 that are respectively installed in a plurality of refrigerant lines for each function on the refrigerant distribution panel 330 to control a refrigerant flow rate, and a controller (also referred to as control circuit, control circuitry, processor, etc.) 350 that comprehensively controls the refrigerant valves 340 for integrated heat management of the vehicle interior 20 and the battery 30. In this case, the refrigerant module 300 may use the phase-changed refrigerant for cooling/heating according to a function of the refrigerant line 10.

The composite heat exchanger 310 may perform a cooling function by absorbing heat from the vehicle interior 20 and/or waste heat from electrical components (e.g., motor, inverter, etc.) through a refrigerant and releasing it to the outside, and a heating function by absorbing heat from the outside through a refrigerant and releasing it to the vehicle interior 20.

The battery chiller 320 may cool the battery 30 using a coolant that has been heat-exchanged through a refrigerant.

The refrigerant distribution panel 330 may function to direct the refrigerant flowing into an interior through the refrigerant line 10 to the composite heat exchanger 310 and the battery chiller 320. The refrigerant distribution panel 330 may be, for example, a manifold or a receptacle (e.g., valve receptacle), into which one or more refrigerant valves 330 may be installed. The refrigerant distribution panel 330 may form a plurality of panel-assembled passages for distribution to each of the composite heat exchanger 310 and the battery chiller 320, and may be provided with multiple valve mounting portions 331 in function-specific passages. The valve mounting portions 331 may have a hardware structure capable of assembling the refrigerant valves 340 in a cartridge manner. Herein, the passages formed in the refrigerant distribution panel 330 may be substantially connected to the refrigerant line 10, and may play a same role in distributing the refrigerant for each function, which are collectively referred to as refrigerant lines 10 hereinafter.

The refrigerant valves 340 may respectively be inserted into a plurality of valve mounting portions 331 formed in the refrigerant distribution panel 330 to be mounted in a cartridge format. Conversely, during replacement, the refrigerant valves 340 may be removed from the valve mounting portions 331.

The coolant module 400 may be provided as a modular device capable of controlling a multi-valve 430 and a reservoir tank 440 to activate an electric water pump 410 or a coolant line 420,

For example, the multi-valve 430 may be formed of six hexa valves.

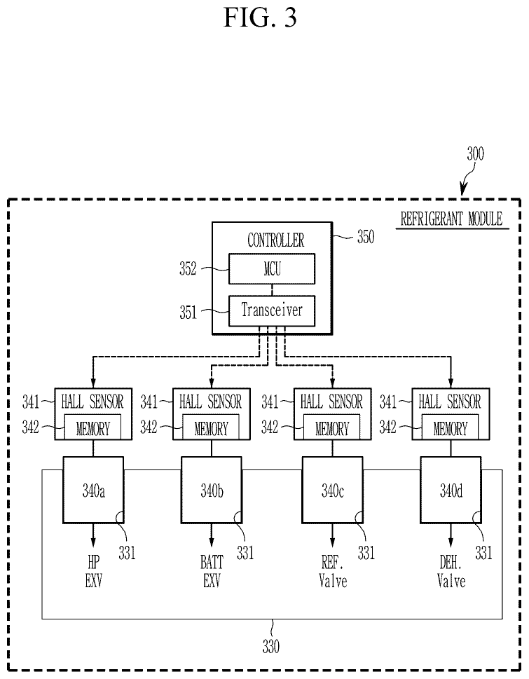

FIG. 3 illustrates a schematic block diagram for describing a control configuration of an example integrated refrigerant module.

Referring to FIG. 3, the control configuration of the integrated refrigerant module 300 may include a plurality of refrigerant valves 340 each installed in a functional cooling line (also referred to as cooling line) 10, a hall sensor 341 respectively installed in the refrigerant valves 340, a controller 350 having a single transceiver 351 and a micro controller unit (MCU) 352 and integratedly controlling the refrigerant valves 340 through the hall sensor 341.

For example, the refrigerant valves 340 may include a first refrigerant valve 340a, a second refrigerant valve 340b, a third refrigerant valve 340c, and a fourth refrigerant valve 340d. However, a number of refrigerant valves 340 installed is not limited thereto and may be increased or decreased depending on a design and/or need of the refrigerant module 300.

At least one of the first refrigerant valve 340a, the second refrigerant valve 340b, the third refrigerant valve 340c, or the fourth refrigerant valve 340d may be provided as an expansion valve and/or a ball valve for uniform refrigerant flow and hydraulic pressure control of the composite heat exchanger 310 or the battery chiller 320.

The hall sensor 341 may store unique identification information (e.g., identifier, identification, etc.) (hereinafter referred to as “hall sensor ID”) in a non-volatile memory 342 equipped in a hall IC (integrated circuit). At least in some example embodiments, the hall sensor 341 (and its memory 342) may be integrated into (e.g., installed in) a corresponding refrigerant valve 340 and thus may be replaced together with the corresponding refrigerant valve 340 when the corresponding refrigerant valve 340 is replaced. In some other example embodiments, the hall sensor 341 may be implemented separately from the refrigerant valve 340, and the refrigerant valve 340 may be replaced without the corresponding hall sensor 341 also being replaced.

The hall sensor 341 may match (e.g., map, associate, etc.) the refrigerant valve ID and hysteresis value correction information (also referred to as valve correction information or value, valve calibration information or value, valve adjustment information or value, etc.) according to an error thereof during initial calibration of the installed refrigerant valve 340 with the hall sensor ID to stores it in the memory 342.

The controller 350 may be equipped with a single (e.g., centralized) transceiver 351 and a micro controller unit (MCU) (e.g., centralized MCU) 352, and may use these to comprehensively manage the refrigerant valves 340. The controller 350 may be a centralized controller that is capable of controlling two or more refrigerant valves 340.

The controller 350 may be electrically connected (e.g., via CAN, LIN, etc.) to the refrigerant valves 340 and/or their hall sensors 341 via the transceiver 344 to transmit and receive control signals and data.

The controller 350 may store at least one program and data for controlling the maintenance method of the refrigerant module in the memory of the MCU 352 and thereby may comprehensively manage the refrigerant valves 340.

The controller 350 may individually control an opening amount (e.g., opening degree) of each refrigerant valve 340 considering functions thereof and paths and positions of the installed passages.

During manufacturing of a refrigerant module in a factory, the controller 350 may perform initial calibration on the refrigerant valves 340 initially mounted in the refrigerant distribution panel 330 to correct an error out of an allowable error range and may store valve correction information in the memory 342 of each (installed) hall sensor 341. In other words, the initial calibration may be performed on the plurality of refrigerant valves 340 to determine (e.g., generate) a valve calibration value for each of the plurality of refrigerant valves, and each valve calibration value (e.g., corresponding valve calibration value) may be stored in a memory of a hall sensor installed in the corresponding refrigerant valve 340 of the plurality of refrigerant valves 340. Thereafter, if a failure (e.g., abnormality) occurs in one refrigerant valve (e.g., existing (e.g., old) first refrigerant valve 340a) and it is replaced, the controller 350 may correct tolerance of the replacement refrigerant valve (e.g., new second refrigerant valve 340a) by utilizing the valve correction information stored in the memory 342 of the corresponding hall sensor 341. In at least some example embodiment(s), if a refrigerant valve 340 is replaced, the corresponding hall sensor 341 and the memory 342, which are installed in the refrigerant valve 340, may also be replaced. In some other example embodiment(s), if a refrigerant valve 340 is replaced, the corresponding hall sensor 341 and the memory 342 may not be replaced and remain with the refrigerant module 300.

In this way, if a single refrigerant valve of a refrigerant module is replaced (e.g., with a new refrigerant valve or with the same (repaired, serviced) refrigerant valve), the controller 350 may perform tolerance correction using valve correction information stored in the memory 342 of the corresponding hall sensor 341, thereby improving system performance and reliability.

This controller 350 for the purpose may be implemented by using a set (e.g., predetermined, prewritten, preprogrammed, etc. at manufacture time) program (e.g., instructions, software, etc.) and a processor that is driven according to a program, and the program may be programmed to perform each operation of a maintenance method of the refrigerant module.

The maintenance method of the refrigerant modules will be described in more detail with reference to the drawing below.

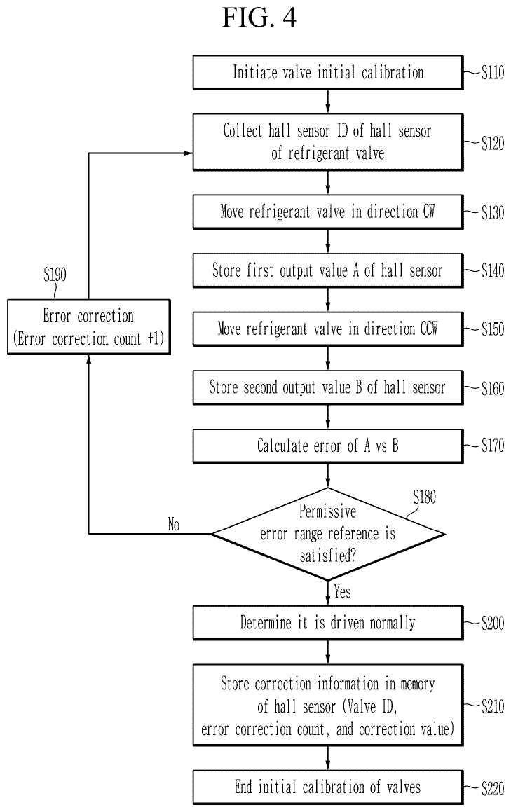

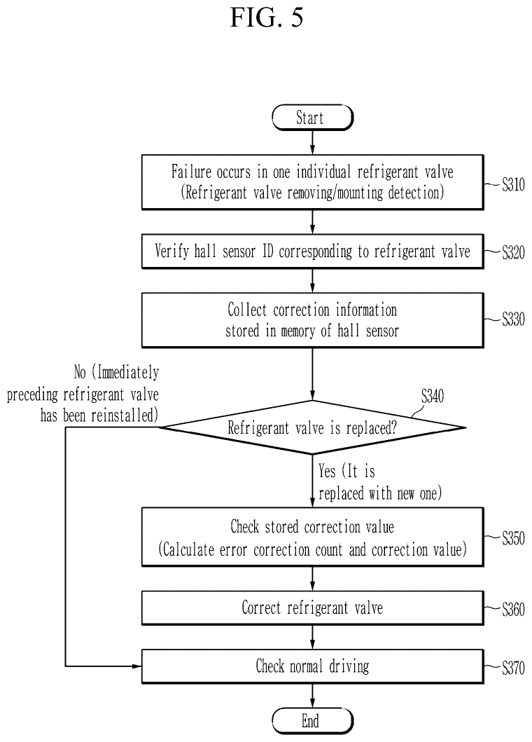

FIG. 4 and FIG. 5 illustrate example operation methods of a refrigerant module of a heat pump system.

The refrigerant module of the vehicle heat pump system and the maintenance method thereof, with reference to FIGS. 4 and 5, may include an operation of performing an initial calibration of a plurality of refrigerant valves mounted on a refrigerant distribution panel of the refrigerant module by the controller 350; an operation of storing valve calibration information according to initial calibration in a memory of a hall sensor installed in each refrigerant valve by the controller 350; an operation of collecting (e.g., receiving, obtaining, retrieving, etc.) the valve calibration information stored in the memory of the installed hall sensor by the controller 350 if a single refrigerant valve is replaced due to a failure; and an operation of correcting (e.g., calibrating) a tolerance of the replacement (e.g., new, repaired, etc.) refrigerant valve using the valve calibration information.

Hereinafter, a maintenance method for a refrigerant module will be described with reference to FIGS. 4 and 5, and a scenario for an initial calibration of a valve when assembling the refrigerant module and a scenario for performing maintenance when replacing the valve will be separately described.

FIG. 4 illustrates a flowchart for describing an initial calibration method during production of a refrigerant module.

Referring to FIG. 4, the controller 350 of the refrigerant module 300 may initiate an initial valve calibration (S110) when the refrigerant valve 340 is assembled and electrically connected to the refrigerant distribution panel 330. Multiple refrigerant valves 340 may be provided in a cartridge type, and may be assembled in the respective valve mounting portions 331 formed on the refrigerant distribution panel 330.

The controller 350 may collect (e.g., receive, obtain, etc.) a hall sensor ID of the hall sensor 341 belonging to the refrigerant valve(s) 340 via the transceiver 351 during initial calibration of the refrigerant valve(s) (S120). In this case, if the collection of the hall sensor ID is successful, the controller 350 may control (drive) the refrigerant valve 340 through the hall sensor 341.

The controller 350 may move (e.g., rotate) the refrigerant valve 340 in a clockwise direction CW (e.g., first direction) by a certain movement amount (e.g., rotational angle) (S130), and may store a first output value A of the hall sensor 341 according to the movement amount (S140).

Next, the controller 350 may move (e.g., rotate) the refrigerant valve 340 in a certain movement amount in a counterclockwise direction CCW (e.g., second direction opposite of the first direction) (S150), and may store a second output value B of the hall sensor 341 accordingly (S160). Herein, the directions CW and CCW may be understood as operating (e.g., controlling) the opening of the refrigerant valve 340 by opening and closing.

The controller 350 may check (e.g., compare) the first output value A and the second output value B of the hall sensor 341 to calculate an error C (e.g., a difference between the first output value A and the second output value B) (S170), and may check whether the error C satisfies a reference permissive error range (S180). The reference permissive error range may be a value that is set to determine whether the refrigerant valve 340 is driven normally (e.g., operating within a predetermined normal operational range) and the tolerance, and may have upper and lower allowable limits (±) centered on an absolute reference (e.g., zero point). This reference permissible error range may be established through repeated experiments or pre-defined algorithms (e.g., programs, probabilistic models, artificial intelligence (AI) learning).

If the error does not satisfy the reference permissible error range (S180; No), the controller 350 may correct (e.g., adjust, etc.) the error C of the refrigerant valve 340, and may increment an error correction count by a predetermined increment value (e.g., 1) (S190). In addition, the error may be recalculated by repeating the above test process (S120 to S170). Herein, the controller 350 may correct an error by generating a valve correction value (also referred to as valve calibration value) for correcting (e.g., calibrating) a deviation between the error C and the upper and lower limits (±) of the reference permissible error range.

On the other hand, if the error satisfies the reference permissible error range (S180; yes), the controller 350 may determine that the refrigerant valve 340 is driven normally (S200). In this case, the controller 350 may store valve correction information in the memory 342 of the hall sensor 341, including a hall sensor ID, a refrigerant valve ID, an error correction count, and a valve correction value for each count (S210). For example, if the error correction count accumulated for the refrigerant valve 340 includes multiple instances (e.g., a total of two times), the controller 350 may store first and second correction values cumulatively in the memory 342 of the hall sensor 341. The accumulated and stored correction values may be used to correct (e.g., calibrate) a hysteresis of a replacement refrigerant valve when the refrigerant valve is replaced with a new one due to a failure of the original refrigerant valve.

Thereafter, the controller 350 may end the initial calibration of the corresponding valves (S220) when it is confirmed that all the refrigerant valves 340 applied to the refrigerant module 300 are driven normally.

Thereafter, the vehicle may be mass-produced through subsequent processes.

FIG. 5 illustrates a flowchart for describing a maintenance method during replacement (e.g., removal and/or reinstallation) of a refrigerant valve.

Referring to FIG. 5, a scenario will be described assuming that a failure (e.g., abnormality) occurs in one of the refrigerant valves applied to the refrigerant module of a vehicle heat pump system and that it is replaced.

A failure may occur in one of the individual refrigerant valves applied to the refrigerant module 300 of a customer vehicle (S310).

At a maintenance station, a malfunctioning (e.g., abnormal) refrigerant valve 340 may be removed from a refrigerant distribution panel 330 of the refrigerant module 300 and a normally driven refrigerant valve is installed in its position (S320). Herein, the normally driven refrigerant valve may be a removed refrigerant valve that has been repaired (e.g., refurbished, serviced, etc.) and reinstalled or a new refrigerant valve.

The controller 350 may collect (e.g., receive, obtain, retrieve, etc.) the hall sensor ID of a hall sensor ID corresponding to the position of the removed refrigerant valve 340 and collect valve correction information (e.g., valve calibration value) stored in the memory 342 when a malfunctioning single refrigerant valve 340 (e.g., and its corresponding hall sensor 341 and memory 342) is removed and a replacement refrigerant valve 340 (e.g., the removed refrigerant valve or a new removed refrigerant valve) may be installed in the refrigerant distribution panel 330 (S330). In this case, the controller 350 may analyze the valve correction information to obtain a hall sensor ID, a current refrigerant valve ID (e.g., the refrigerant valve ID of the replacement refrigerant valve 340), an error compensation count, and a valve correction value for each count.

The controller 350 may determine whether the refrigerant valve has been replaced (e.g., removed, reinstalled, etc.) (S340) by comparing the current refrigerant valve ID in the valve correction information with an immediately preceding stored refrigerant valve ID. The immediately preceding stored refrigerant valve may be identified from information stored in the memory of the MCU 352 just before.

In this case, the controller 350 may determine that the refrigerant valve has been replaced with a new refrigerant valve if the current refrigerant valve ID and the immediately preceding stored refrigerant valve ID (e.g., last stored) are different (S340; yes). Then, the controller 350 may check the correction value stored in the valve correction information (S350), and may perform hysteresis correction (e.g., calibration) for the new replacement refrigerant valve 340 using the correction value (S360). In this case, if the accumulated error correction count in the valve correction information includes multiple instances (e.g., a total of two times or more), the controller 350 may perform tolerance correction using a sum of the correction values (e.g., the first and second correction values).

Thereafter, if the controller 350 confirms the normal driving of (e.g., determines operational conditions of) the refrigerant valve 340 (S370), it may update the hall sensor ID and valve correction information stored in the MCU 352 before terminating the replacement process.

On the other hand, in the operation S340, the controller 350 may determine that the immediately preceding refrigerant valve has been reassembled (e.g., reused, reinstalled, etc.) if the current refrigerant valve ID and the immediately preceding refrigerant valve ID are the same (S340; No), and if it is confirmed that the refrigerant valve 340 is driven normally without correction (S370), it may terminate the replacement process.

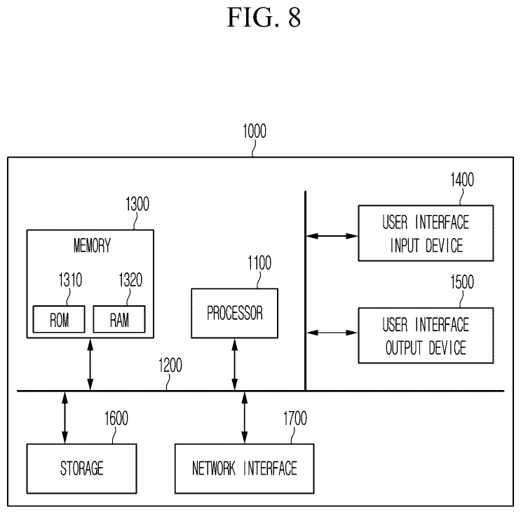

FIG. 8 shows an example computing system (e.g., a computing device of a vehicle or any other apparatus). One or more controllers, processors, etc. described herein (e.g., the controller 350, the MCU 352, the transceiver 351, the hall sensors 341, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure provides a method for maintaining a refrigerant module of a vehicle heat pump system performed by an integrated controller including a single micro controller unit (MCU) and a transceiver, the method including performing initial calibration for a plurality of refrigerant valves mounted in a refrigerant distribution panel of the refrigerant module by the controller, storing valve correction information according to the initial calibration in a memory of a hall sensor installed in each of the refrigerant valves by the controller, collecting valve correction information stored in the memory of the installed hall sensor by the processor when the single refrigerant valve is replaced due to a failure, and correcting tolerance of a replaced refrigerant valve using the valve correction information by the controller.

The performing of the initial calibration may include collecting an hall sensor ID of the hall sensor belonging to a refrigerant valve through the transceiver, moving the refrigerant valve in a clockwise direction CW by a certain level and storing a first output value of the hall sensor according to the movement, moving the refrigerant valve in a counterclockwise direction CCW by a certain level and storing a second output value of the hall sensor according to the movement, and verifying whether an error calculated by comparing the first output value and the second output value satisfies a permissible error range reference.

In addition, the verifying of whether the error satisfies the permissible error range reference may include correcting the error of the refrigerant valve and incrementing an error correction count is incremented by ‘1’ if the error does not satisfy the permissible error range reference and performing the initial calibration repeatedly.

In addition, the verifying of whether the error satisfies the permissible error range reference may include determining that the refrigerant valve is driven normally if the error satisfies the permissible error range reference, and storing the valve correction information including at least one of a hall sensor ID, a refrigerant valve ID, an error correction count, or a valve correction value for each count in the memory of the hall sensor.

In addition, the storing of it in the memory of the hall sensor may include, if an accumulated error correction count for the refrigerant valve includes multiple instances, storing a correction value for each of the counts cumulatively in the memory of the hall sensor.

In addition, the collecting of the valve correction information may include a failure occurring in any one refrigerant valve applied to the refrigerant module, and collecting a hall sensor ID of a corresponding position and valve correction information stored in a memory when a faulty refrigerant valve is removed and reinstalled in the refrigerant distribution panel.

In addition, the collecting of the valve correction information may include obtaining at least one of a hall sensor ID, a current refrigerant valve ID, an error correction count, or a valve correction value for each count by analyzing the valve correction information.

In addition, the collecting of the valve correction information may include: determining whether the refrigerant valve has been replaced by comparing a current refrigerant valve ID in the valve correction information with an immediately preceding stored refrigerant valve ID, and determining that the refrigerant valve has been replaced with a new refrigerant valve if the current refrigerant valve ID and the immediately preceding refrigerant valve ID are different.

In addition, the correcting tolerance of the replaced refrigerant valve may include performing hysteresis correction on the replaced refrigerant valve by checking the correction value stored in the valve correction information, and if the accumulated error correction count in the valve correction information includes multiple instances, tolerance may be corrected by using a sum of the correction values of multiple times.

In addition, the collecting of the valve correction information may include determining that an immediately preceding refrigerant valve has been reassembled if the current refrigerant valve ID and the immediately preceding refrigerant valve ID are the same, and terminating a replacement process when it is confirmed that the refrigerant valve is driven normally without correction. cording to The present disclosure provides a refrigerant module of a heat pump system for a vehicle, including a plurality of refrigerant valves each installed on a functional cooling line formed in a refrigerant distribution panel, a hall sensor installed in each of the refrigerant valves, and a controller configured to include a single micro controller unit (MCU) and a transceiver and integratedly control the refrigerant valves through the hall sensor, and the controller may store valve correction information according to initial calibration of the refrigerant valves in the memory of each installed hall sensor, and may correct the tolerance of a replaced refrigerant valve by using the valve correction information stored in the memory of the installed hall sensor when a single refrigerant valve is replaced due to a failure.

In addition, the refrigerant module of the vehicle heat pump system may further include a composite heat exchanger configured to cool or heat a vehicle interior using a refrigerant; and a battery chiller configured to cool a battery using a coolant that undergoes heat exchange via the refrigerant.

In addition, the hall sensor may store valve correction information according to the refrigerant valve ID and hysteresis correction in a memory by matching it with the hall sensor ID during initial calibration of the installed refrigerant valve.

In addition, the controller may determine whether the refrigerant valve has been replaced by comparing a current refrigerant valve ID in the valve correction information with an immediately preceding stored refrigerant valve ID, and if the two refrigerant valve IDs are different, may determine that the refrigerant valve has been replaced with a new refrigerant valve and correct tolerance of the replaced refrigerant valve.

In addition, the controller may determine that the immediately preceding refrigerant valve has been reassembled if the two valve IDs are the same, and terminates a replacement process without correcting the refrigerant valve.

As described above, hysteresis correction may be performed for individual refrigerant valve replacements by utilizing the memory of hall sensors individually installed on multiple refrigerant valves, thereby enhancing performance and reliability of the cooling module.

In addition, it may be possible to determine whether a malfunctioning refrigerant valve has been replaced, and when a valve replacement occurs, hysteresis correction may be performed without initial valve calibration, thereby facilitating maintenance and servicing.

Additionally, by omitting (removing) the individually provided MCU and transceiver on the existing refrigerant valve side, product performance may be maintained while reducing the number of components, thereby achieving cost savings and enhancing price competitiveness.

The embodiments of the present disclosure are not implemented only through the devices and/or methods described herein, but may also be implemented through a program (e.g., instructions, software) for realizing one or more functions corresponding to the configuration of the disclosed example embodiment(s), a storage medium on which the program (e.g., instructions) is recorded, etc., and such implementation may be implemented by a specialist in the technical field to which the present disclosure belongs, based on the description of the embodiments described above.

While this disclosure has been described in connection with example embodiment(s), it is to be understood that the disclosure is not limited to the disclosed example embodiment(s), but, on the contrary, is intended to cover various modifications and equivalent dispositions included within the spirit and scope of the appended claims.

What is claimed is:

1. A method performed by an apparatus of a vehicle, the method comprising:
performing, by control circuit of a vehicle heat pump, an initial calibration on a plurality of refrigerant valves, mounted in a refrigerant distribution panel associated with the vehicle heat pump, to determine a plurality of pieces of valve calibration information, wherein each of the plurality of pieces of valve calibration information is associated with one of the plurality of refrigerant valves;
storing, by the control circuit, each of the plurality of pieces of valve calibration information in a memory of a hall sensor installed for a corresponding refrigerant valve of the plurality of refrigerant valves;
based on a first refrigerant valve of the plurality of refrigerant valves being replaced due to a failure, obtaining, by the control circuit, a first piece of the valve calibration information stored in the memory of the hall sensor installed in the first refrigerant valve; and
calibrating, based on the first piece of the valve calibration information, tolerance of a second refrigerant valve that replaced the first refrigerant valve.

2. The method of claim 1, wherein the performing of the initial calibration comprises, for each refrigerant valve of the plurality of refrigerant valves:
obtaining, via a transceiver of the vehicle heat pump, a hall sensor identifier of the hall sensor corresponding to the refrigerant valve;
moving the refrigerant valve in a first direction by a first predetermined movement amount and storing a first output value of the hall sensor corresponding to the refrigerant valve;
moving the refrigerant valve in a second direction, opposite of the first direction, by a second predetermined movement amount and storing a second output value of the hall sensor corresponding to the refrigerant valve; and
verifying whether a difference between the first output value and the second output value satisfies a reference error range.

3. The method of claim 2, wherein the verifying comprises:
based on the difference between the first output value and the second output value not satisfying the reference error range, incrementing an error correction count for the refrigerant valve; and
performing the initial calibration repeatedly.

4. The method of claim 2, wherein the verifying comprises:
determining, based on the difference between the first output value and the second output value satisfying the reference error range, that the refrigerant valve is operating within a normal operational range, and
wherein each of the plurality of pieces of valve calibration information comprises at least one of: the hall sensor identifier, a refrigerant valve identifier of the refrigerant valve, an error correction count, or a valve correction value for each count.

5. The method of claim 4, wherein the verifying further comprises:
based on the error correction count being greater than a threshold count, storing, in the memory of the hall sensor corresponding to the refrigerant valve, a correction value for each of the error correction count cumulatively.

6. The method of claim 1, wherein the obtaining of the first piece of the valve calibration information comprises:
detecting the failure in the first refrigerant valve; and
obtaining, based on the first refrigerant valve being reinstalled in the vehicle heat pump as the second refrigerant valve, a hall sensor identifier, of the hall sensor installed in the first refrigerant valve, and the first piece of the valve calibration information stored in the memory of the hall sensor installed in the first refrigerant valve.

7. The method of claim 1, wherein the obtaining of the first piece of the valve calibration information comprises:
obtaining at least one of: a hall sensor identifier, a current refrigerant valve identifier, an error correction count, or a valve correction value for each count.

8. The method of claim 7, wherein the obtaining of the first piece of the valve calibration information further comprises:
determining whether the first refrigerant valve is different from the second refrigerant valve by comparing the current refrigerant valve identifier in the valve calibration information with an immediately preceding stored refrigerant valve identifier; and
determining, based on the current refrigerant valve identifier and the immediately preceding stored refrigerant valve identifier being different, that the second refrigerant valve is different from the first refrigerant valve.

9. The method of claim 7, wherein the calibrating of the tolerance of the second refrigerant valve comprises:
performing hysteresis correction on the second refrigerant valve based on the valve correction value stored in the first piece of the valve calibration information; and
calibrating, based on the error correction count in the first piece of the valve calibration information being greater than a threshold count, the tolerance using a correction value sum for the error correction count.

10. The method of claim 7, wherein the obtaining of the first piece of the valve calibration information comprises:
determining, based on the current refrigerant valve identifier being identical to an immediately preceding stored refrigerant valve identifier, that the first refrigerant valve has been reinstalled as the second refrigerant valve; and
terminating a replacement process without calibration based on confirming that the second refrigerant valve is operating within a predetermined normal operational range.

11. An apparatus comprising:
a plurality of refrigerant valves each installed on a functional cooling line formed in a refrigerant distribution panel;
a plurality of hall sensors, wherein each hall sensor of the plurality of hall sensors is installed for a corresponding refrigerant valve of the plurality of refrigerant valves, and wherein each hall sensor of the plurality of hall sensors comprises a memory; and
a control circuit comprising a micro controller unit (MCU) and a transceiver and configured to control the plurality of refrigerant valves via the plurality of hall sensors,
wherein the control circuit is further configured to:
perform an initial calibration on the plurality of refrigerant valves to determine a plurality of pieces of valve calibration information, wherein each of the plurality of pieces of valve calibration information is associated with one of the plurality of refrigerant valves;
store each of the plurality of pieces of valve calibration information in the memory of a corresponding hall sensor of the plurality of hall sensors; and
based on a first refrigerant valve of the plurality of refrigerant valves being replaced due to a failure, calibrate, based on a first piece of the valve calibration information stored in the memory of the hall sensor corresponding to the first refrigerant valve, tolerance of a second refrigerant valve that replaced the first refrigerant valve.

12. The apparatus of claim 11, further comprising:
a composite heat exchanger configured to cool or heat a vehicle interior using a refrigerant; and
a battery chiller configured to cool, using a coolant that undergoes heat exchange via the refrigerant, a battery.

13. The apparatus of claim 11, wherein each of the plurality of pieces of valve calibration information comprises a refrigerant valve identifier and a hysteresis correction value that are matched with a hall sensor identifier during the initial calibration.

14. The apparatus of claim 11, wherein the control circuit is further configured to:
determine whether the second refrigerant valve is different from the first refrigerant valve by comparing a current refrigerant valve identifier in the first piece of the valve calibration information with an immediately preceding stored refrigerant valve identifier; and
based on the current refrigerant valve identifier and the immediately preceding stored refrigerant valve identifier being different, determine that the second refrigerant valve is different from the first refrigerant valve and calibrate the tolerance of the second refrigerant valve.

15. The apparatus of claim 11, wherein the control circuit is further configured to:
based on a current refrigerant valve identifier in the first piece of the valve calibration information and an immediately preceding stored refrigerant valve identifier being identical, determine that the first refrigerant valve has been reinstalled as the second refrigerant valve, and terminate a replacement process without calibrating the second refrigerant valve.

16. An apparatus comprising:
a valve receptacle configured to receive one or more valves that are configured to control a flow rate of a refrigerant flowing through a refrigerant line; and
a control circuit configured to:
based on a first valve, comprising a first memory, being installed in the valve receptacle, transmit, to the first valve, a first signal configured to cause the first valve to rotate in a first direction by a predetermined amount;
transmit, to the first valve, a second signal configured to cause the first valve to rotate in a second direction by the predetermined amount;
determine, based on a difference between a first measured rotation amount of the first valve according to the first signal and a second measured rotation amount of the first valve according to the second signal, a first calibration value for the first valve; and
store, in the first memory of the first valve, the first calibration value.

17. The apparatus of claim 16, wherein the control circuit is further configured to:
detect that the first valve is removed from the valve receptacle and a second valve is installed in the valve receptacle, wherein the second valve comprises a second memory; and
based on detecting that the second valve is installed in the valve receptacle, retrieve a second calibration value stored in the second memory of the second valve.

18. The apparatus of claim 17, wherein the control circuit is further configured to:
obtain, based on the first valve being installed in the valve receptacle, a first valve identifier of the first valve; and
obtain, based on the first valve being removed from the valve receptacle and the second valve being installed in the valve receptacle, a second valve identifier of the second valve.

19. The apparatus of claim 18, wherein the control circuit is further configured to:
based on the second valve identifier being different from the first valve identifier stored in the second memory, applying the retrieved second calibration value to the second valve.

20. The apparatus of claim 18, wherein the control circuit is further configured to:
based on the second valve identifier being identical to the first valve identifier stored in the second memory, determining an operational condition of the second valve without applying the retrieved second calibration value to the second valve.
